(19) United States
(12) Patent Application Publication
(10) Pub. No.: US 2012/0154364 A1
(43) Pub. Date: Jun. 21, 2012

(54) ELECTRONIC READING APPARATUS AND OPERATION METHOD

(75) Inventor: Yao-Tsung Chang, Taipei Hsien (TW)

(73) Assignee: WISTRON CORPORATION, New Taipei City (TW)

(21) Appl. No.: 13/242,592

(22) Filed: Sep. 23, 2011

(30) Foreign Application Priority Data
Dec. 20, 2010 (TW) 99144832

(51) Int. Cl. G09G 5/00

(52) U.S. Cl. 345/211

(57) ABSTRACT

An electronic reading apparatus and an operation method thereof are provided. The electronic reading apparatus includes an electronic paper, a photoelectrical conversion unit, energy storing unit, a power module, and a controller. The photoelectrical conversion unit is superposed by the electronic paper and converts light energy to electrical energy. The power module stores the electrical energy to the energy storing unit for charging the energy storing unit. The controller converts at least one part of the electronic paper into transparency in a time interval, such that light energy passes through the electronic paper and is received by the photoelectrical conversion unit.

This application claims the benefit of Taiwan application Serial No. 99144832, filed Dec. 20, 2010, the subject matter of which is incorporated herein by reference.

### BACKGROUND OF THE INVENTION

1. Field of the Invention

The invention relates in general to an electronic apparatus, and more particularly to an electronic reading apparatus and an operation method thereof.

2. Description of the Related Art

Along with the advance in technology, portable electronic apparatuses have gradually become assisting tools to people in their everydayness. Portable electronic apparatuses, being handy and convenient to carry with, have gained greater and greater popularity, and provide more and more functions. As the awareness of environmental conservation arises, conventional printing matters are gradually electronized. The electronic reading apparatus, which provides a reading effect similar to that provided by printed matters, is power saving and is suitable for long duration of reading. One of the favorite features of the electronic reading apparatus is that the display screen still keeps the display frame even after the power is turned off.

The power source of the electronic reading apparatus is critical. If the electronic reading apparatus uses a power source that is free of petroleum pollution and gas discharge that may add to the greenhouse effect, the electronic reading apparatus will be a superior green product.

### SUMMARY OF THE INVENTION

The invention is directed to an electronic reading apparatus and an operation method thereof. Light energy is converted into the electrical energy required by the electronic reading apparatus by way of controlling the transparency of at least one part of the electronic paper. The electronic reading apparatus and the operation method thereof of the invention not only save the area occupied by the photoelectrical conversion unit and the electronic paper but also reduce the volume of the electronic reading apparatus. Furthermore, when the electronic reading apparatus is in use, the photoelectrical conversion unit stores the electrical energy, such that both the efficiency and the capacity in the storage of the electrical energy are increased.

According to a first aspect of the present invention, an electronic reading apparatus is provided. The electronic reading apparatus includes an electronic paper, a photoelectrical conversion unit, an energy storing unit, a power module, and a controller. The photoelectrical conversion unit superposed by the electronic paper converts light energy to electrical energy. The power module stores the electrical energy to the energy storing unit for charging the energy storing unit. The controller converts at least one part of the electronic paper into transparency in a time interval, such that light energy passes through the electronic paper and is received by the photoelectrical conversion unit.

According to a second aspect of the present invention, an operation method of electronic reading apparatus is provided. An electronic reading apparatus is provided, wherein the electronic reading apparatus includes an electronic paper, a photoelectrical conversion unit and an energy storing unit and a photoelectrical conversion unit superposed by the electronic paper. The operation method includes the following steps. At least one part of the electronic paper is converted into transparency in a time interval, such that light energy passes through the electronic paper and is received by the photoelectrical conversion unit. Light energy is converted into electronic energy. The electrical energy is stored to the energy storing unit for charging the energy storing unit.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a circuit block diagram of an electronic reading apparatus;

FIG. 2A shows a schematic diagram of the appearance of an electronic reading apparatus when an electronic paper 11 is in a transparency mode;

FIG. 2B shows a schematic diagram of the appearance of an electronic reading apparatus when an electronic paper 11 is in a display mode;

FIG. 2C shows a schematic diagram of the appearance of an electronic reading apparatus when an electronic paper 11 is in a partial transparency mode;

FIG. 3A shows a top view of an electronic reading apparatus when an electronic paper 11 is in a transparency mode;

FIG. 3B shows a top view of an electronic reading apparatus when an electronic paper 11 is in a display mode;

FIG. 3C shows a top view of an electronic reading apparatus when an electronic paper 11 is in a partial transparency mode;

FIG. 4A, FIG. 4B, FIG. 4C and FIG. 4D respectively show schematic diagrams of a part of an electronic paper;

FIG. 5 shows an operation method of an electronic reading apparatus according to a first embodiment of the invention; and

FIG. 6 shows an operation method of an electronic reading apparatus according to a second embodiment of the invention.

### DETAILED DESCRIPTION OF THE INVENTION

To make an electronic reading apparatus become a green product, an electronic reading apparatus and an operation method thereof are disclosed in the following embodiments. The electronic reading apparatus includes an electronic paper, a photoelectrical conversion unit, energy storing unit, a power module, and a controller. The photoelectrical conversion unit, superposed by the electronic paper, converts light energy to electrical energy. The power module stores the electrical energy to the energy storing unit for charging the energy storing unit. The controller converts at least one part of the electronic paper into transparency in a time interval, such that light energy passes through the electronic paper and is received by the photoelectrical conversion unit.

The operation method of electronic reading apparatus includes the following steps. Firstly, an electronic reading apparatus is provided, wherein the electronic reading apparatus includes an electronic paper, a photoelectrical conversion unit superposed by the electronic paper, and an energy storing unit. Next, at least one part of the electronic paper is converted into transparency in a time interval, such that light energy passes through the electronic paper and is received by the photoelectrical conversion unit. Then, light energy is converted into electrical energy by the photoelectrical conversion unit. Lastly, the electrical energy is stores to the energy storing unit for charging the energy storing unit.

### First Embodiment

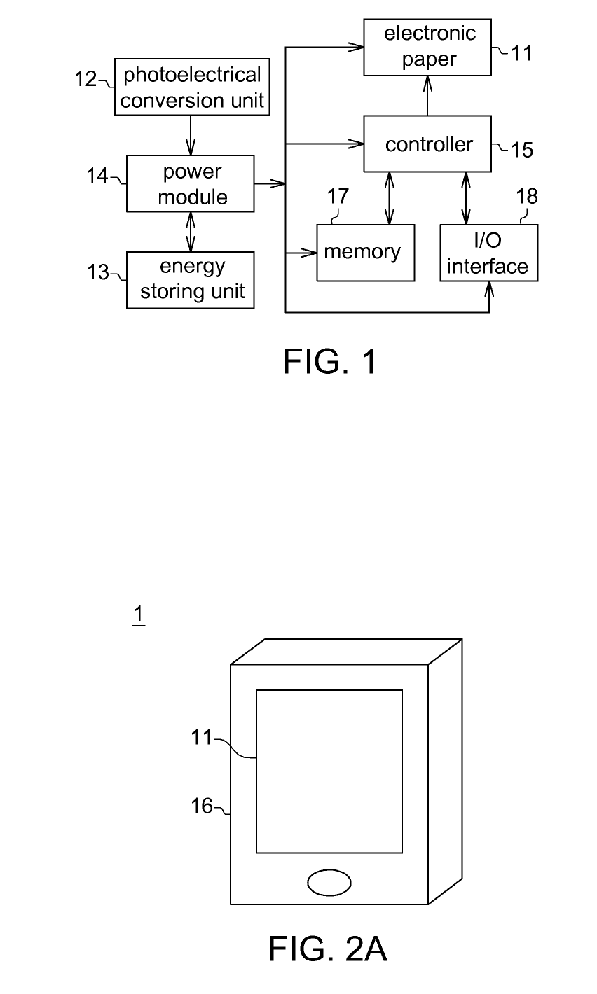

Referring to FIG. 1, a circuit block diagram of an electronic reading apparatus is shown. The electronic reading apparatus 1 includes an electronic paper 11, a photoelectrical conversion unit 12, an energy storing unit 13, a power module 14, a controller 15, a memory 17 and an I/O interface 18, wherein the photoelectrical conversion unit 12 and the energy storing unit 13 are respectively realized by such as a solar cell and a battery. The electronic paper 11 can be realized by any electronic paper with transparency function such as the electronic paper adopting the e-skin technology of the Royal Philips Electronics for providing the electronic paper with transparency effect. In addition, the following embodiments are exemplified by a layer of electronic paper. However, the invention is not limited thereto, and the electronic reading apparatus 1 can adopt multiple layers of electronic paper with different ink colors to present a color frame.

The photoelectrical conversion unit 12 superposed by the electronic paper 11 converts the energy of the light into electrical energy. In comparison to the conventional parallel arrangement of the electronic paper 11 and the photoelectrical conversion unit 12 (for example, the electronic paper 11 and the photoelectrical conversion unit 12 are disposed at two lateral sides of the e-reader case, or, the electronic paper 11 is connected to an external independent solar power module), in the present embodiment of the invention, the photoelectrical conversion unit 12 is disposed under the electronic paper 11 to avoid occupying too large area of the electronic reading apparatus.

According to an alternative arrangement, the electronic paper 11 and the photoelectrical conversion unit 12 are respectively disposed on the front surface and the rear surface of the electronic reading apparatus 1. Under such arrangement, when the electronic reading apparatus 1 is in use, the electronic paper 11 faces upwards (facing the direction of the light) for the convenience of reading and the photoelectrical conversion unit 12 located on the rear surface of the electronic reading apparatus 1 faces downwards (backs on the direction of the light). Since the photoelectrical conversion unit 12 cannot be directly radiated by the light or absorb the light energy of sufficient light, the energy storing unit 13 cannot store sufficient electrical energy. In comparison to the above arrangement in which the electronic paper 11 and the photoelectrical conversion unit 12 are respectively disposed on the front surface and the rear surface of the electronic reading apparatus 1, in the present embodiment of the invention, the photoelectrical conversion unit 12 is disposed under the electronic paper 11 and both the photoelectrical conversion unit 12 and the electronic paper 11 face the same direction. Thus, when the electronic reading apparatus 1 is in use, the electronic paper 11 and the photoelectrical conversion unit 12 both face upwards (face the direction of the light), so that the photoelectrical conversion unit 12 can absorb the light energy of sufficient light and the energy storing unit 13 can store sufficient electrical energy.

The power module 14 charges the energy storing unit 13 with the electrical energy outputted from the photoelectrical conversion unit 12. In addition, when the power of the energy storing unit 13 is insufficient, the power required by the electronic reading apparatus 1 can be immediately provided by the photoelectrical conversion unit 12 and the power module 14 to assure that the power supply of the electronic reading apparatus 1 will not be interrupted. The memory 17 provides a necessary memory space for the controller 15. The I/O interface 18 receives a control instruction. The controller 15 controls the electronic paper 11 to enter different modes, such as transparency mode, display mode or partial transparency mode, according to the control instruction. In addition, the controller 15 can also control the electronic paper 11 to switch between the transparency mode, the display mode and the partial transparency mode according to the remaining capacity detected by the power module 14. The controller 15 controls the electronic paper 11 to enter the transparency mode, the display mode or the partial transparency mode to achieve different implementations. The transparency mode, the display mode and the partial transparency mode of the electronic paper 11 are elaborated in subsequent disclosure.

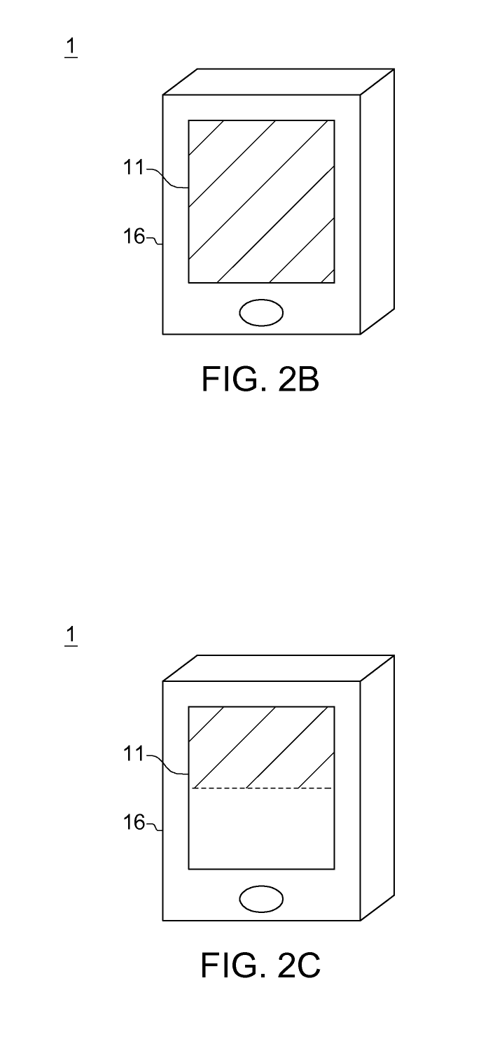

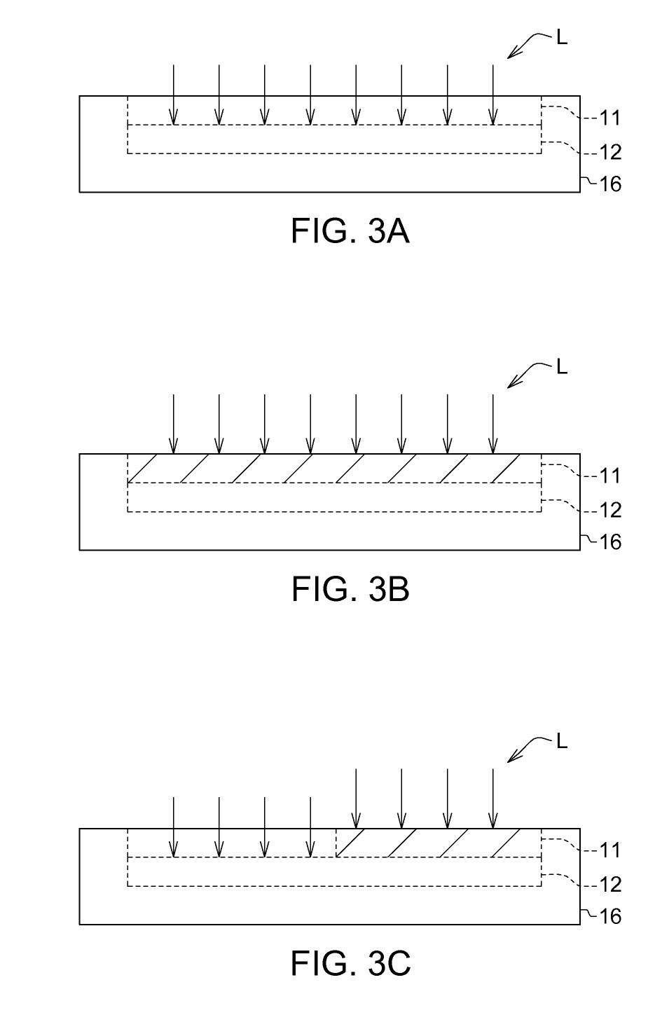

Referring to FIG. 1, FIG. 2A and FIG. 3A. FIG. 2A shows a schematic diagram of the appearance of an electronic reading apparatus when an electronic paper 11 is in a transparency mode. FIG. 3A shows a top view of an electronic reading apparatus when an electronic paper 11 is in a transparency mode. The electronic reading apparatus 1 further includes a casing 16 for accommodating the electronic paper 11, the photoelectrical conversion unit 12, the energy storing unit 13, the power module 14, the controller 15, the memory 17 and the I/O interface 18. The electronic paper 11 is exposed from the casing 16, and the photoelectrical conversion unit 12 is disposed under the electronic paper 11.

When the controller 15 controls the electronic paper 11 to enter the transparency mode in a certain time interval, the electronic paper 11 does not display data and the totality of the electronic paper 11 is converted into transparency, such that the light energy of the light L passes through the electronic paper 11 and is received by the photoelectrical conversion unit 12. In the time interval, the electronic reading apparatus 1 can be charged with the light energy of the external light L.

Referring to FIG. 1, FIG. 2A and FIG. 3A. When the electronic reading apparatus 1 enters a power-off mode or a standby mode, the controller 15 converts the totality of the electronic paper 11 into transparency in the time interval, such that light energy passes through the electronic paper 11 and is received by the photoelectrical conversion unit 12. The photoelectrical conversion unit 12 converts light energy of the light L into electrical energy so as to provide power to the power module 14. When the electronic reading apparatus 1 enters a power-off mode or a standby mode, power is provided to the power module 14 by the photoelectrical conversion unit 12 instead, such that the operation of the electronic reading apparatus 1 will not be affected even when the energy storing unit 13 cannot provide power to the power module 14.

Referring to FIG. 1, FIG. 2B and FIG. 3B. FIG. 2B shows a schematic diagram of the appearance of an electronic reading apparatus when an electronic paper 11 is in a display mode. FIG. 3B shows a top view of an electronic reading apparatus when an electronic paper 11 is in a display mode. When the controller 15 controls the electronic paper 11 to enter the display mode in another time interval, the electronic paper 11 displays data and none of the electronic paper 11 is converted into transparency. The user can read the data with the electronic reading apparatus 1 in the time interval.

Referring to FIG. 1, FIG. 2C and FIG. 3C. FIG. 2C shows a schematic diagram of the appearance of an electronic reading apparatus when an electronic paper 11 is in a partial transparency mode. FIG. 3C shows a top view of an electronic reading apparatus when an electronic paper 11 is in a partial transparency mode. When the controller 15 controls the electronic paper 11 to enter the partial transparency mode in other time interval, a part of the electronic paper 11 is converted into transparency for charging the energy storing unit and another part of the electronic paper 11 displays data. In the said time interval, the user can read data with the electronic reading apparatus 1, and at the same time, the electronic reading apparatus 1 is charged by an external light. The full page data originally displayed in the display mode can be downsized and displayed in the partial transparency mode. Or, the full page data originally displayed in the display mode can be divided into multiple pages and displayed page by page in the partial transparency mode. Since the electronic reading apparatus 1 can provide both the reading function and the charging function, it will not happen to the user that data cannot be read with the electronic reading apparatus 1 during important occasions.

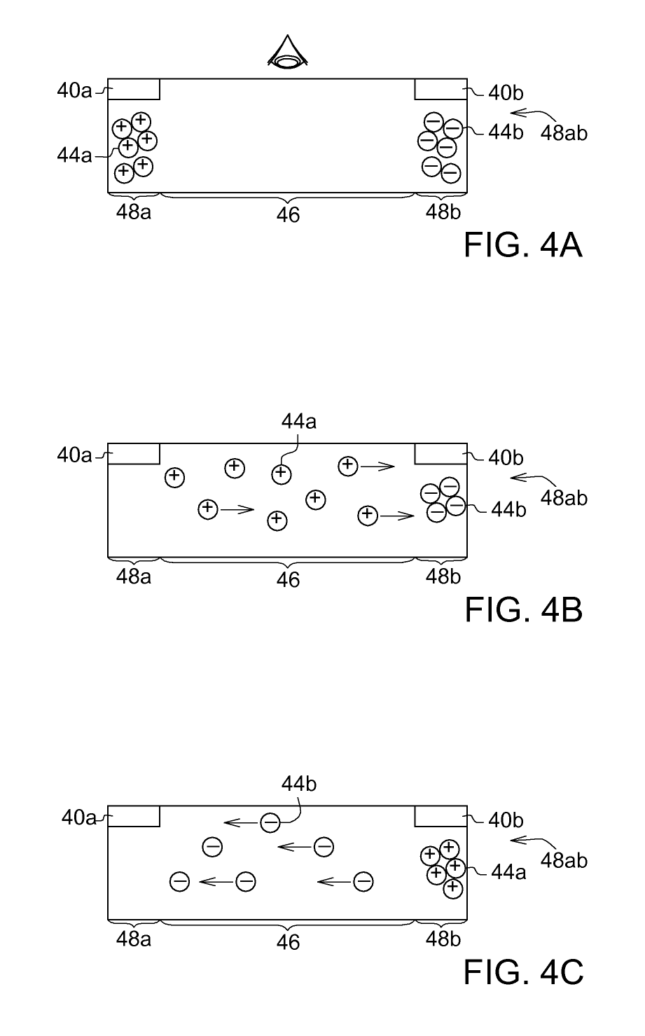

Referring to FIG. 4A, FIG. 4B, FIG. 4C and FIG. 4D, schematic diagrams of a part of an electronic paper are respectively shown. The electronic paper 11 includes a layer chamber 48ab. The layer chamber 48ab includes electrodes 40a and 40b which are disposed at the corners opposite to the layer chamber 48ab. The visible region 46 is located between the concentrating region 48a and the concentrating region 48b.

Referring to FIG. 4A. When a negative voltage and a positive voltage are respectively applied to the electrode 40a and the electrode 40b, the ink particles 44a with positive charges are attracted by the electrode 40a and move towards the concentrating region 48a, and the ink particles 44b with negative charges are attracted by the electrode 40b and move towards the concentrating region 48b. Since the ink particles 44a and the ink particles 44b respectively move towards two lateral sides of the layer chamber 48ab, the visible region 46 of the layer chamber 48ab is converted into transparency.

Referring to FIG. 4B. When a positive voltage and a negative voltage are respectively applied to the electrode 40a and the electrode 40b, the ink particles 44a with positive charges will be attracted by the electrode 40b and move towards the concentrating region 48a. As the ink particles 44b with negative charges move slower than the ink particles 44a with positive charges, the ink particles 44a which move faster will be distributed over the visible region 46, such that the visible region 46 of the layer chamber 48ab will show the color of the ink particles 44a. The moving rate of the ink particles 44b can be controlled by adjusting the characteristics of the ink particles 44b and the intensity of the charges.

Referring to FIG. 4C. When a positive voltage and a negative voltage are respectively applied to the electrode 40a and the electrode 40b for a period of time, the ink particles 44a which move faster will be attracted to the concentrating region 48b by the electrode 40b. The ink particles 44b with negative charges which move slower will be distributed over the visible region 46, such that the visible region 46 of the layer chamber 48ab will show the color of the ink particles 44b.

Referring to FIG. 4D. When a positive voltage and a negative voltage are respectively applied to the electrode 40a and the electrode 40b for a period of time and then a negative voltage and a positive voltage are applied thereto instead, the ink particles 44b with negative charges which moves slower will be distributed over the visible region 46, and the ink particles 44a with positive charges will be attracted by the electrode 40b and move towards without reaching the concentrating region 48a. Meanwhile, if the positive voltage and the negative voltage are no more applied to the electrode 40a and the electrode 40b, then the visible region 46 of the layer chamber 48ab will show a mixed color of the ink particles 44a and the ink particles 44b.

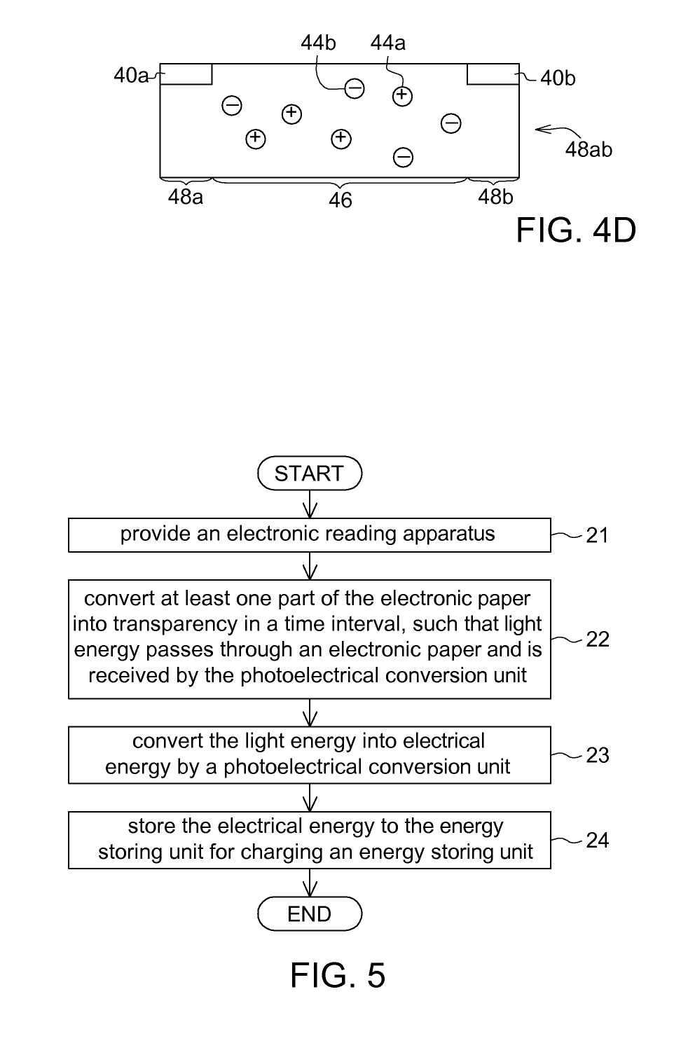

Referring to FIG. 1 and FIG. 5. FIG. 5 shows an operation method of an electronic reading apparatus according to a first embodiment of the invention. The operation method of the electronic reading apparatus 1 includes the following steps. Firstly as indicated in step 21, an electronic reading apparatus 1 is provided, wherein the electronic reading apparatus 1 includes an electronic paper 11, a photoelectrical conversion unit 12 superposed by the electronic paper 11, and an energy storing unit 13. Next, as indicated in step 22, at least one part of the electronic paper 11 is converted into transparency by the controller 15 in a time interval, such that the light energy of the light L passes through the electronic paper 11 and is received by the photoelectrical conversion unit 12. Then, as indicated in step 23, the light energy is converted into electrical energy by the photoelectrical conversion unit 12. Lastly, as indicated in step 24, the electrical energy is stored to the energy storing unit 13 by the power module 14 for charging the energy storing unit 13.

### Second Embodiment

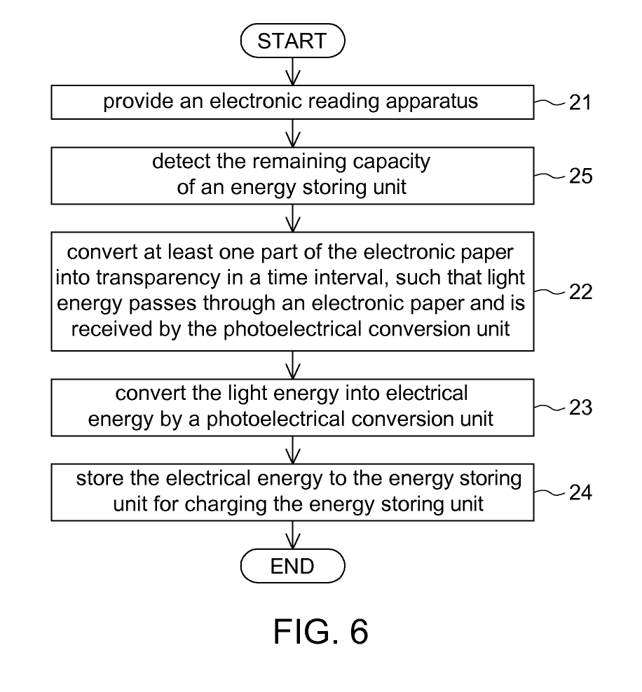

Referring to FIG. 1 and FIG. 6. FIG. 6 shows an operation method of an electronic reading apparatus according to a second embodiment of the invention. The second embodiment is different from the first embodiment mainly in that the operation method of the electronic reading apparatus of the second embodiment further includes step 25 in addition to steps 21˜24. As indicated in step 25, a remaining capacity of an energy storing unit 13 is detected by a controller 15 with a power module 14. When the remaining capacity drops to a threshold, then as indicated in step 21, at least one part of the electronic paper 11 is converted into transparency by the controller 15, such that the power module 14 charges the energy storing unit 13. Consequently, the electronic reading apparatus 1 is automatically charged according to the remaining capacity of the energy storing unit 13, largely improving the convenience of use of the electronic reading apparatus 1. Furthermore, the user can input a control instruction via an I/O interface 18, and after the control instruction is received by the I/O interface 18, the controller 15 controls the electronic paper 11 to enter the operation mode corresponding to the control instruction.

Moreover, the controller 15 determines the areas of the display region and the transparent region of the electronic paper 11 according to the remaining capacity. For example, when the remaining capacity of the energy storing unit 13 is lower, the electronic paper 11 is controlled by the controller 15 to display a smaller display region and a larger transparent region, such that the charging rate can be increased. To the contrary, when the remaining capacity of the energy storing unit 13 is higher, the electronic paper 11 is controlled by the controller 15 to display a larger display region and a smaller transparent region.

The invention is exemplified by a number of embodiments above. However, any designs in which the photoelectrical conversion unit is superposed by an electronic paper, and at least one part of the electronic paper is converted into transparency in a time interval such that the photoelectrical conversion unit converts light energy into electronic energy are within the scope of protection of the invention. The electronic reading apparatus and the operation method thereof of the invention not only save the area occupied by the photoelectrical conversion unit and the electronic paper but also reduce the volume of the electronic reading apparatus. Furthermore, when the electronic reading apparatus is in use, the photoelectrical conversion unit stores the electrical energy, such that both the efficiency and the capacity in the storage of the electrical energy are increased. When the electronic reading apparatus enters a power-off mode or a standby mode, the necessary power is provided by the photoelectrical conversion unit instead. In addition, the areas of the display region and the transparent region of the electronic paper converted into transparency is controlled by the electronic reading apparatus according to the level of the remaining capacity, and the lower the remaining capacity, the smaller the display region and the larger the transparent region.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic reading apparatus, comprising:
an electronic paper with transparency characteristics;
a photoelectrical conversion unit superposed by the electronic paper and used for converting light energy to electrical energy;
an energy storing unit;
a power module storing the electrical energy to the energy storing unit for charging the energy storing unit; and
a controller controlling converts at least one part of the electronic paper into transparency in a time interval, such that light energy passes through the electronic paper and is received by the photoelectrical conversion unit.

2. The electronic reading apparatus according to claim 1, wherein the controller controls another part of the electronic paper to display data in the first time interval.

3. The electronic reading apparatus according to claim 1, wherein the controller converts the totality of the electronic paper into transparency in a second time interval.

4. The electronic reading apparatus according to claim 1, wherein the controller in a second time interval controls the totality of the electronic paper to display data.

5. The electronic reading apparatus according to claim 1, wherein the controller detects a remaining capacity of the energy storing unit with the power module, and when the remaining capacity drops to a threshold, the controller converts at least one part of the electronic paper into transparency in a time interval, such that the power module charges the energy storing unit.

6. The electronic reading apparatus according to claim 1, further comprising:
a casing for accommodating the electronic paper, the photoelectrical conversion unit, the energy storing unit, the power module and the controller, wherein the electronic paper is exposed from the casing, and the photoelectrical conversion unit is disposed under the electronic paper.

7. The electronic reading apparatus according to claim 1, wherein the controller detects a remaining capacity of the energy storing unit with the power module, and determines a display region and a transparent region of the electronic paper according to the remaining capacity.

8. The electronic reading apparatus according to claim 1, wherein when the electronic reading apparatus enters a power-off mode, the controller converts the totality of the electronic paper into transparency in a second time interval.

9. The electronic reading apparatus according to claim 1, wherein when the electronic reading apparatus enters a standby mode, the controller converts the totality of the electronic paper into transparency in a second time interval.

10. The electronic reading apparatus according to claim 1, wherein the controller controls another part of the electronic paper to display data in the first time interval, the controller converts the totality of the electronic paper into transparency or to display data in a second time interval.

11. The electronic reading apparatus according to claim 10, further comprising:
a memory providing a necessary memory space for the controller;
an I/O interface receiving a control instruction, wherein the controller controls the electronic paper to enter different modes according to the control instruction; and
a casing for accommodating the electronic paper, the photoelectrical conversion unit, the energy storing unit, the power module and the controller, wherein the electronic paper is exposed from the casing, and the photoelectrical conversion unit is disposed under the electronic paper.

12. The electronic reading apparatus according to claim 11, wherein when the electronic reading apparatus enters a power-off mode, the controller converts the totality of the electronic paper into transparency in the second time interval, when the electronic reading apparatus enters a standby mode, the controller converts the totality of the electronic paper into transparency in the second time interval.

13. The electronic reading apparatus according to claim 11, wherein the controller detects a remaining capacity of the energy storing unit with the power module, and determines a display region and a transparent region of the electronic paper according to the remaining capacity, and when the remaining capacity drops to a threshold, the controller converts at least one part of the electronic paper into transparency, such that the power module charges the energy storing unit.

14. An operation method of electronic reading apparatus, comprising:
providing an electronic reading apparatus comprising an electronic paper with transparency characteristics, a photoelectrical conversion unit superposed by the electronic paper, and an energy storing unit;
converting at least one part of the electronic paper into transparency in a time interval, such that light energy passes through the electronic paper and is received by the photoelectrical conversion unit;
converting the light energy into electrical energy by the photoelectrical conversion unit; and
storing the electrical energy to the energy storing unit for charging the energy storing unit.

15. The operation method according to claim 14, wherein a portion of another part of the electronic paper is controlled to display data in the first time interval.

16. The operation method according to claim 14, the totality of the electronic paper is converted into transparency in a second time interval.

17. The operation method according to claim 14, further comprising:
controlling the electronic paper to display data in a second time interval.

18. The operation method according to claim 14, further comprising:
detecting a remaining capacity of the energy storing unit;
wherein when the remaining capacity drops to a threshold, at least one part of the electronic paper is converted into transparency for charging the energy storing unit in a time interval.

19. The operation method according to claim 14, wherein the electronic reading apparatus further comprises a casing for accommodating the electronic paper, the photoelectrical conversion unit and the energy storing unit, the electronic paper is exposed from the casing, and the photoelectrical conversion unit is disposed under the electronic paper.

20. The operation method according to claim 14, further comprising:
detecting a remaining capacity of the energy storing unit; and
determining a display region and a transparent region of the electronic paper according to the remaining capacity.

21. The operation method according to claim 14, further comprising:
converting the totality of the electronic paper into transparency in a second time interval when the electronic reading apparatus enters a power-off mode.

22. The operation method according to claim 14, further comprising:
converting the totality of the electronic paper into transparency in a second time interval when the electronic reading apparatus enters a standby mode.

23. The operation method according to claim 14, further comprising:
controlling the electronic paper into transparency or to display data in a second time interval.

24. The operation method according to claim 23, wherein a portion of another part of the electronic paper is controlled to display data in the first time interval.

25. The operation method according to claim 24, wherein the electronic reading apparatus further comprises a casing for accommodating the electronic paper, the photoelectrical conversion unit and the energy storing unit, the electronic paper is exposed from the casing, and the photoelectrical conversion unit is disposed under the electronic paper.

26. The operation method according to claim 25, wherein when the electronic reading apparatus enters a power-off mode, the totality of the electronic paper is converted into transparency in the second time interval.

27. The operation method according to claim 25, wherein when the electronic reading apparatus enters a standby mode, the totality of the electronic paper is converted into transparency in the second time interval.

28. The operation method according to claim 25, further comprising:
detecting a remaining capacity of the energy storing unit; and
determining a display region and a transparent region of the electronic paper according to the remaining capacity
wherein when the remaining capacity drops to a threshold, at least one part of the electronic paper is converted into transparency for charging the energy storing unit.
